(19) United States
(12) Patent Application Publication
(10) Pub. No.: US 2015/0025943 A1
(43) Pub. Date: Jan. 22, 2015

(54) SYSTEM AND METHOD FOR MEASURING, COMPARING AND IMPROVING WORK FORCE COMMUNICATION RESPONSE TIMES, PERFORMANCE, EFFICIENCY AND EFFECTIVENESS

(71) Applicants: Paul Schmidt, Rocky Hill, CT (US); Christopher J. DeBenedictis, Branford, CT (US); Albert R. Subbloie, JR., Orange, CT (US); Jaan Leemet, Austin, TX (US)

(72) Inventors: Paul Schmidt, Rocky Hill, CT (US); Christopher J. DeBenedictis, Branford, CT (US); Albert R. Subbloie, JR., Orange, CT (US); Jaan Leemet, Austin, TX (US)

(21) Appl. No.: 14/172,509

(22) Filed: Feb. 4, 2014

Related U.S. Application Data
(60) Provisional application No. 61/862,146, filed on Aug. 5, 2013.
(60) Provisional application No. 61/856,341, filed on Jul. 19, 2013.

(51) Int. Cl. G06Q 10/06

(52) U.S. Cl. CPC G06Q 10/06393
USPC 705/7.39

(57) ABSTRACT

A system and method for measuring the efficiency and effectiveness of individuals and automated systems by using transaction based measurements of communications that are normalized into a velocity score to depict excellent performance versus poor performance. Individual velocity scores may be aggregated to grade a person, a group, a department, a company or an industry or geography. The velocity score includes a plurality of weights that are used to provide higher or lower velocity scores depending on criteria selected by the entity.

### FIELD OF THE INVENTION

The invention relates to a system and method for measuring and comparing communications efficiency and effectiveness of an individual(s) and/or groups of individuals through responsiveness over a variety of common workplace tools and systems. In particular, the system allows an entity to capture and normalize data across tools to provide a standard set of measurement metrics allowing the entity to determine their workers communications efficiency and effectiveness.

### BACKGROUND OF THE INVENTION

Companies know that good communication is one of the main keys to business success. In the past ten to fifteen years, tremendous advances have been made in improving lines of communication. These include the improvement and expansion of systems and services relating to mobile phones, email, text messaging, instant messaging, social networking and mobile computing just to name a few.

Whereas in the past, the primary means of business communications may have been limited to paper correspondence, facsimile and voice correspondence; today companies are taking advantage of the multitude of communications means for communicating with customers, with suppliers, vendors and business partners, and with individuals within the company. For example, workers in today's workforce regularly communicate via email, text messaging and instant messaging. These communications can occur on a desk top computer or on a mobile computing device (e.g. smart phone, tablet, etc.). In this way, an individual does not have to be in a particular location (e.g., in their office with access to their computer) to receive and send communications. These can occur virtually anywhere the worker has connectivity.

However, the explosion of new and different means of communication, companies have strived to take advantage of the many differing communication mediums. This includes the purchase of computers, mobile computing devices and voice and data services to enable their workers to be as “plugged in” as possible in an effort to maximize communication in the company. These purchases come at a hefty price however. It can be quite costly to purchase or lease, personal computers, servers, switches, hubs, routers, wireless systems, mobile smart phones, and tablets for use by workers. Likewise the costs associated with telecommunications network services, and all the internal personnel required to purchase, install, maintain and trouble-shoot the telecom systems can be high.

Additionally, the individual is also driving change via demand for personal choice of devices, apps, and communication methods not provided by the enterprise but still used to conduct business. This trend has been referred to as the “Consumerization of IT”, “Bring your own device” (BYOD), or “Bring your own app” (BYOA). Companies still need to manage, measure and control the communications, data, and network access even while they are not paying for the devices or usage.

While there is no question that these variously described systems when properly used can greatly increase the efficiency and effectiveness of workers in the company (individual(s) and/or groups of individuals), this still leaves the question of how does a company determine, with all the above described communications tools, how effective their workers are in using these tools provided; or how effective, efficient, and responsive are their workers, groups, departments, or company as a whole are in communicating both intra-company between each other as well as inter-company with prospects, customers, partners, affiliates, agencies, etc. Likewise, how does a company receive feedback relating to how effective their workers are at addressing problems or situations that are communicated via the tools provided?

It would be advantageous for a company to know if individuals or groups of individuals that are particularly good at utilizing the various communications tools provided. These individuals or groups of individuals can be acknowledged for their success and efficiency fostering a positive atmosphere in the company and additional success. Likewise, it would also be advantageous for a company to know if individuals or groups of individuals have not been very successful at utilizing the various communications tools provided, or are not responsive in communications. In this manner, additional training can be provided relating to the tools to increase efficiency and productivity or simple behavioral change by the individual's (and corresponding group as a whole) through visibility of their measurement scores compared to goals or others.

The advent of many differing types of communications means, a communications trail is often developed (e.g., an email thread, etc.) that can be reviewed after the communications has been completed. Not only would it be advantageous for a company to know if its workers were efficiently utilizing the communications tools provided, it would further be advantageous if the company could received feedback on how effective its workers performed their jobs through the communications medium utilized.

While longer periods of time provide an indication of trending, the longer the period becomes, the less impact a single event will have. For this reason, the most interesting measurements of velocity may be daily, weekly, or monthly values. When looking at a year or more, individual events will often become imperceptible.

It may also be possible that some events are truly exceptions to the rule and should be allowed some override by some arbitrator/moderator. Take for example, a personal contact that happens to use your work email by mistake, or some special circumstances that have a higher purpose than the day to day normal activities that velocity is set out to measure.

### SUMMARY OF THE INVENTION

Accordingly, what is desired then is a system and method that allows an entity to determine how efficient their workers are in using communications tools.

Efficiency does not have to be limited to the mastering of the tool, or the speed at which one responds alone, but also may include the quality of the response and it's suitability to the conversation at hand.

It is further desired to provide a system and method that allows an entity to capture and normalize data across communications tools to provide a standard set of measurement metrics relating to communications efficiency.

It is still further desired to provide a system and method that allows an entity to receive feedback as to how effective their workers are at performing their jobs through the various communications mediums utilized.

It is also desired to provide a system and method that allows the benchmarking of measurement results at various levels of detail and aggregation as well as ability to combine these measurements with additional qualitative and quantitative metrics both internal and external such as revenue or financial, business operational, or customer satisfaction ratings, survey or 3^{rd} party rating info, etc. to provide correlations between performance and communication efficiency, effectiveness and responsiveness.

It is further desired to allow variances to how velocity scores are measured and presented to users including methods of gamification or contest in the spirit of encouraging participants to improve their scores.

While a velocity determination takes into account a measurement of how quickly a person responds to a communication, it also includes correlation of 3^{rd} party items like a customer satisfaction survey, or actual sales results to see how increases or decreases in velocity affect these measures.

Further, while much of the velocity score is based on the collection of raw velocity scores from communications devices with variable weights assigned to these values, it is also desirable to have external stimuli and input to these measurements. This input could be, for example, from an HR system or organizational chart that would assign stricter weights on management than on factory workers. It may also be raw input such as customer feedback received in written form, which can be factored back into a previously measured velocity measurement.

These and other objects are achieved by a system and method that measures a “velocity” of workers communications. When the term “velocity” is used herein, it refers to how efficient, effective and/or responsive an individual(s) or group of individuals are using communications tools. Communications tools can include any tools used for communication including, but not limited to, voicemail, email, text messaging, instant messaging, social media (e.g., Facebook, Twitter, Linkedin, etc.), application interaction and so on that may be used with a telephone (LAN line), a mobile telephone, a smart phone, a tablet, a personal computer (desk top, lap top, notebook, etc.), a personal communications device and wearable technology (smart watches, glasses, etc.) and the like.

An individual who always seems to be on top of a situation, is able to respond to queries immediately with exactly the information needed, at the right level of detail. Someone who is able to effectively drive initiatives through his or her organization by knowing the strengths and weaknesses of their team. Such an individual would be considered to have a high velocity as they are able to get things done quickly and accurately the first time. They are known to deliver consistent results faster, without error, and in a cost effective manner.

In contrast, an individual who may be difficult to reach, requires a high level of explanation or hand holding, or who might miss a directive, misunderstand an instruction, or misdirect the efforts of their staff is more likely to add confusion, create delays, and inefficiencies in an organization. Whether intentional or not, communication gaps, bad process, the misuse (or lack thereof) of communications tools, or even conflicting goals due to organizational misalignment may all be factors. The end result is low velocity, which damages the organization as a whole.

The first individual is generally considered a good worker, whereas the latter is not. The latter situation may be caused by lack of timely information or misunderstanding of instructions leaving a potentially good employee delivering low velocity.

It is also not uncommon to see the effective and efficient individual go unnoticed as they consistently deliver on time and on budget. In contrast, the problematic department or manager may find themselves in the spotlight as some glaring problem comes to light where through heroic efforts, the problem(s) are solved. While the heroic efforts and resulting solution(s) are commendable, it would be preferable for the problem never to have occurred in the first place (possibly as a result of poor communication).

In some organizations, individuals of both categories are known to management and to staff, and perhaps even throughout the organization. However, one objective of the invention is to quantify this perception into a measurable set of metrics. Velocity measurement is a method by which an entity can consistently measure results, rather than base assessments on the exceptions and the highly visible events (e.g., the heroic efforts described above).

While measuring velocity has it's basis in transactional measurement of communications events across different methods of communications, these individual velocity measurements such as the response to an email, a voice mail, or a text message can be aggregated and captured to look at velocity for a particular communications method (e.g., email, voicemail, text messaging, etc.) or even for a particular set of events (e.g., solving a customer problem or the like). Multiple events can also be combined and linked together to capture velocity of a set of events, or a sprint or initiative or effort. For example, solving a customer problem from the time the request comes in (e.g., via email or trouble ticket), as it works through the organization (by email, phone call, text message, person to person discussion, up until the time the ticket is closed and the customer expresses his/her satisfaction. It is of interest to capture the overall velocity score of such an activity, though the correlation of the various atomic evens that span the activity over multiple communications methods.

Further, while measuring individual velocity provides useful information, individual velocity is not enough to obtain a good velocity score or quotient across an entire group. An efficient and effective individual working on the wrong problem or driving in the wrong direction can cause more harm than good, even if they are achieving objectives perfectly. Capturing aggregate velocities for the individual, the group, and the overall entity and even an industry as a whole provides very valuable information. In fact, the velocity measurement can also be applied to tools and automated systems which have an interaction with humans looking to get information. Examples may be a website that is difficult to navigate or easy to find the information a person is looking for. Another example is a phone answering prompt based system that required too many button pushes, or does not give the option the user is looking for. Aggregate velocities for the users of this system can provide a useful metric at how efficient and effective the system is in achieving its purpose.

A “velocity score” is a value related to a velocity measurement for an individual(s) or group of individuals representing a determined efficiently and responsiveness of the individual(s) or group of individuals. In one aspect, a value of between 0 and 100 could be provided with 0 corresponding to the lowest or worst velocity score and 100 corresponding to the highest or best velocity score. Alternatively, any type of grading or scoring system, including for example, but not limited to and alpha-numeric scoring system could be used.

The resultant velocity score can be used to capture, benchmark and drive operational efficiency and improvements in individuals, tools, and departments of an entity.

The measurement can be tailored towards individual communication mechanisms and mediums allowing one to select the fastest and most efficient (highest velocity) medium for deciding how to deal with a particular person or entity. For example, some individuals respond best to text messages, others to emails, others to voicemail messages. Knowing the velocity of a particular individual or group across various communication mediums allows one to select the communication medium with the highest velocity score to achieve the best efficiency in communication. Accordingly, it is understood that a system may be provided that allows for different communications methods (voice, voicemail, SMS, email, social media, apps, etc.) to have a velocity score based on specific criteria related to the transactional nature of the medium used. This velocity score can be for an individual, for a group of individuals, a department or even for an entire entity.

Alternatively, the system may allow for aggregation of the velocity scores for the various different communications methods so as to provide a composite velocity score that can be applied to individuals, as well as departments, and entities or industries as a whole.

It is understood that, for example, a smart phone typically has multiple communications mediums provided thereon including, email, SMS, Facebook, Twitter, calendar invites, and many more application specific metrics that may be measured for individual raw velocity on a per app basis. Likewise, as discussed above, an aggregate velocity for the device may also be determined according to the individual raw velocity measurements on a per app basis. Access to the individual transactions of each of these apps and devices allows for capturing the raw data to measure and determine velocity for these communications mediums. It should also be noted that some Apps may not provide access to raw metrics or statistics yet these measures can be derived or estimated via traffic patterns or application usage patterns such as forefront activity, CPU usage, generated data traffic, Memory usage, etc.

It should be understood that in one aspect of the invention, the system allows for the inclusion of one or multiple quotient values, weights, and scoring scales by communication or event characteristics in determining a velocity score. For example, a department may desire its workers to utilize email rather than text messaging for communication. Workers that then use email to communicate and respond to various issues could receive a higher velocity score than if they responded via text messaging or voicemail. So, if the entity were utilizing a blended velocity score for the individual, a quick response to an inquiry via email would contribute to receiving the highest velocity score for the individual. Alternatively, if the individual were to quickly respond via a text message, the velocity score would be lower due to using the less desired communications medium.

For measuring velocity, each individual communication medium has characteristics unique to its operation by which a velocity score can be generated. For example, text messages could include response time and/or a word count. Alternatively, voice mail could include the time the message was picked up, an elapsed time before calling back, and potentially the length of the call. Still further, with a meeting invitation, the length of time to accept the invitation could be the primary contributor to the velocity score determination.

The weighting and scoring system may also take into consideration variances in response times due to, for example, the time of day, importance of the message, and/or the individuals involved in the communications. For example, the time of day and day of the week could variously contribute to the “weight” of the individual communication contributing to the overall velocity score. A response time to a communication occurring during normal working hours during the work week would be more heavily weighted than a response time to a communication that occurred either on the weekend or not during normal working hours. In some instances, a response to a communication that occurred during a holiday or in the middle of the night that was responded to early the next business day could potentially achieve a score of 100 (the delay in response during the holiday or during the night would receive a 0 weight allowing the individual to receive a perfect velocity score by responding early the next business day). A system of added weights (or “bonus points”), is also incorporated when the recipient responds in the middle of the night. These weights or additional bonus points are awarded if applicable, but the absence of a response does not harm the users score; i.e. a full 100 point score is obtained if response comes early the next business day, however, with the bonus points/weights the score may be counted multiple times when calculating the aggregate velocity. This is further evident in the examples depicted in the array of events presented herein.

Likewise, the importance of the communication could contribute a weighting of the response where an ‘urgent’ message could be more heavily weighted than a response to a non-urgent communication.

Still further, the individuals involved in the communication could contribute a weight applied to a response to the communication. For example, if a customer sent the communication, the response would be more heavily weighted than a response to a fellow worker or peer. Likewise, if a superior sent a communication, the response could be more heavily weighted than a response to a subordinate. Some communications may have a zero weight applied to them, such as for example, responses to telemarketers or personal communications.

The above are just a few various examples of weights that can be applied to communication responses and are not intended to be limiting. One of skill in the art would understand that many differing weights could be applied to match the business goals desired by an entity.

In another aspect of the invention, in addition to measuring a response time to a communication and applying any of the weighting described above, a velocity score could also include a component including an effectiveness of the response(s). It is understood that an incorrect answer that is provided quickly is not helpful. In some instances, an automatic determination may be possible for certain communications mediums, in other instances it may be required to receive input of the participants in the communication to determine whether the response was accurate and/or helpful in resolving the issue. In one embodiment, the system may allow for the grading of individuals, departments and entities, which would apply to a determination of their overall velocity score. Another contributor to velocity calculation could be the number of messages in the overall thread. For example, perhaps a greater number of messages imply that the matter wasn't resolved in the first message or two.

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The term “communications medium” as used herein means any form of electronic communication which would include a mobile device or some device that is remote from the other participant(s). This may include a phone, text, pager, email system, computer, tablet, app, smart phone, personal smart device and/or wearable technology, or laptop. Often, the communications medium will relate to an application on a device with specific counters for transactions.

The term “network” as used herein includes both networks and internetworks of all kinds, including the Internet, and is not limited to any particular network or inter-network.

The terms “first” and “second” are used to distinguish one element, set, data, object or thing from another, and are not used to designate relative position or arrangement in time.

The terms “coupled”, “coupled to”, “coupled with”, “connected”, “connected to”, and “connected with” as used herein each mean a relationship between or among two or more devices, apparatus, files, programs, media, components, networks, systems, subsystems, and/or means, constituting any one or more of (a) a connection, whether direct or through one or more other devices, apparatus, files, programs, media, components, networks, systems, subsystems, or means, (b) a communications relationship, whether direct or through one or more other devices, apparatus, files, programs, media, components, networks, systems, subsystems, or means, and/or (c) a functional relationship in which the operation of any one or more devices, apparatus, files, programs, media, components, networks, systems, subsystems, or means depends, in whole or in part, on the operation of any one or more others thereof.

The terms “process” and “processing” as used herein each mean an action or a series of actions including, for example, but not limited to, the continuous or non-continuous, synchronous or asynchronous, routing of data, modification of data, formatting and/or conversion of data, tagging or annotation of data, measurement, comparison and/or review of data, and may or may not comprise a program.

The term “communication thread” as used herein means a series of communications related to each other by common topic. An example of a communication thread would be a series of emails including the same subject line that are sent and/or received in sequential fashion. It should be noted that a communication thread is not limited to a single communications medium as a response may be sent on a topic via multiple communications mediums. As an example, an email inquiry may be sent to an individual by a participant where the individual responds to the participant via a text message (sent relatively quickly from the individual's mobile phone), the individual then follows up with an email (including a more detailed response) and then finally the individual may call the participant via the telephone either speaking directly to the participant or leaving a voicemail message. It is also worth noting that multiple communication threads can result from a single thread, such as when a conversation topic changes during an email communication thread, switching from one medium to another, or simply having one subject bring up a number of other problem areas that we want to track separate velocities for.

In one embodiment a system is provided for measuring responsiveness of an individual to a communication comprising a system computer having a storage accessible thereto and a network connection. The system has software executing thereon including a communications data gathering module that gathers data indicative of when a communication is sent via a communication medium, and when a response to the communication is sent. The software further includes a rules module that includes rules for applying a weight to the gathered data and a velocity module generating a velocity score based on the weighted gathered data. The system is provided such that the weight applied to the response time is based on the time of day the communication was sent, the day of the week the communication was sent, the time of day the response was sent, and the day of the week the response was sent. The system is further provided such that the communications medium is selected from the group consisting of: email, text messaging, voicemail, social media, instant messaging or combinations thereof.

In another embodiment a method is provided for measuring responsiveness of an individual to a communication including a system computer having a storage accessible thereto and a network connection. The system computer has software executing thereon and performs the step of gathering communications data, the communications data indicative of: when a communication is sent via a communication medium; and when a response to the communication is sent. The method further includes the step of accessing a rules module including rules and applying a weight to the gathered data for determining a velocity score. The weight applied to the gathered data is based on the time of day the communication was sent, the day of the week the communication was sent, the time of day the response was sent, and the day of the week the response was sent. The method also includes the step of generating a velocity score based on the weighted gathered data. The communications medium is selected from the group consisting of: email, text messaging, voicemail, social media, instant messaging or combinations thereof.

In still another embodiment a system is provided for measuring responsiveness of an individual to a communication comprising a system computer having a storage accessible thereto and a network connection. The system has software executing thereon including a communications data gathering module that gathers data indicative of when a communication is sent via a communication medium and when a response to the communication is sent. The software further includes a rules module that includes rules for applying a weight to the gathered data and a velocity module generating a velocity score based on the weighted gathered data.

Other objects of the invention and its particular features and advantages will become more apparent from consideration of the following drawings and accompanying detailed description.

### BRIEF DESCRIPTION OF THE DRAWINGS

FIG. 1 is a block diagram of one advantageous embodiment of the system.

FIG. 2 is a block diagram of the advantageous embodiment according to FIG. 1.

FIG. 3 is a block diagram of the advantageous embodiment according to FIG. 1.

FIG. 4 is a block diagram of the advantageous embodiment according to FIG. 3.

FIG. 5 is a flow diagram of the advantageous embodiment according to FIG. 1.

### DETAILED DESCRIPTION OF THE INVENTION

Referring now to the drawings, wherein like reference numerals designate corresponding structure throughout the views.

In determining velocity, a velocity score may be generated for individuals, for groups of individuals (departments), for groups of departments (an entity), and even to automated stations and machines. The velocity measurement could further be dependent on the communications media used and transactions that encompass the communication. The events, activities and participants involved in the communication may also factor into the calculation. For an automated system, velocity measurement could involve the number of buttons that have to be pressed to get the answer one needs, the wait/hold time as well as the quality of the information received (based on feedback from the recipient). With regard to email, telephone calls, sms messages etc, the metrics could be related as to how quickly the recipient answers, how clear and accurate the information received is, the need for repeated calls or escalations, and the length of time an email chain may remain open.

The success or failure of a given project requiring the input of multiple participants is tied to the responsiveness of those participants and the ability of the project manager. Often poor communication by one or more of the participants can become the determining factor that negatively affects the project. For this reason, capturing and measuring velocity (of individuals and departments) can provide useful input and constructive feedback to all concerned about how to identify and fix poor communication links.

Communications based devices such as smart phones and computers are commonly used communication methods today. These devices can capture quantitative elements such as response time (number of rings), perhaps length of phone calls, size of text messages, and whether or not phones are answered, and how quickly call backs occur etc. When sending a text message with a question, one can measure the response time in terms of the actual elapsed time it takes to get a response and the originator can assess the quality of the response once it's received.

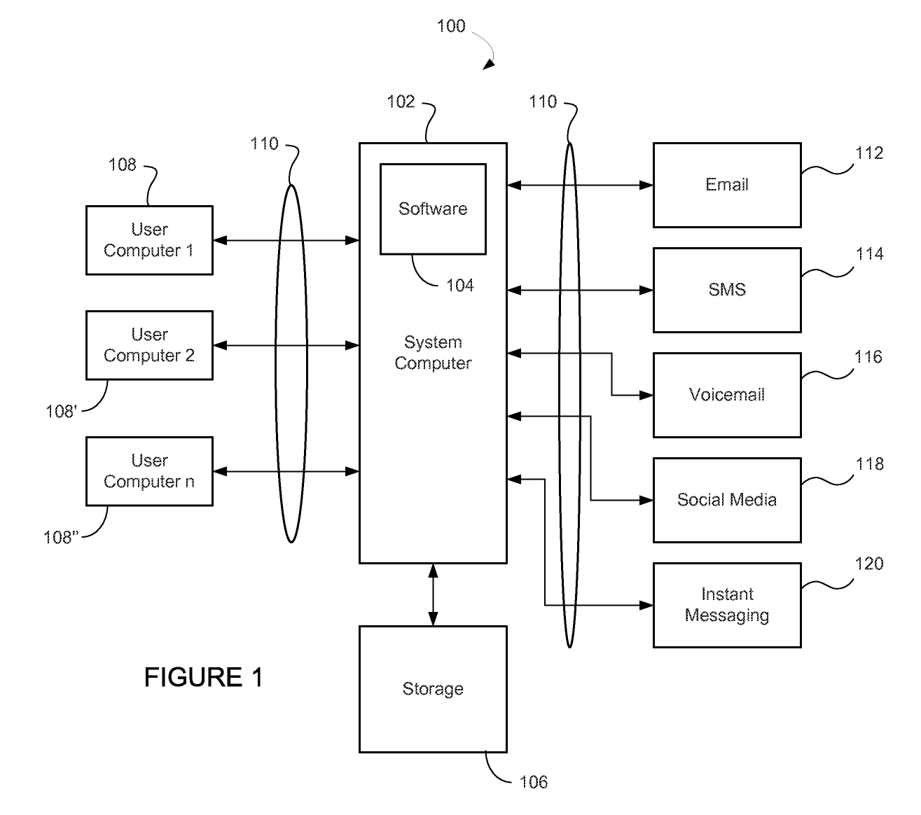

Turning now to FIG. 1, a system 100 for measuring responsiveness of an individual to a communication is provided. The system includes a system computer 102 having software 104 executing thereon. Accessible to system computer 102 is a storage 106 that may comprise any known data storage device including by not limited to a removable or non-removable device, a hard drive, a solid state drive, an optical drive, a thumb drive (such as a USB device), an external drive (either local or connected via a network connection), and the like.

Coupled to system computer 102 are user computers (108, 108′, 108″), which may be connected via a network connection 110. While only three user computers (108, 108′, 108″) are depicted in FIG. 1, it is understood that any number may be connected via network connection 110.

Also depicted in FIG. 1 are various communications mediums inputs including: Email 112, SMS (text messaging) 114, Voicemail 116, Social Media 118 and Instant Messaging 120. All of these various forms of communication may be monitored and raw velocity data may be received by system computer 102 via network connection 110′.

The system 100 may further include a number of event sensors and meters (software) used to capture the raw data required to measure and report velocity. The sensors and meters utilized will vary depending on the device, the technology, and the communication medium monitored. It is often the case that multiple technologies and communications mediums are used in a single communication thread (e.g., emails may be responded to from multiple devices so the thread may span multiple devices and must be pulled together based on other device independent factors such as subject line). As an example, email may have multiple criteria for determining velocity. From a transactional standpoint, each email can be considered a unique transaction. To calculate velocity on a transactional basis, the response time to receive the mail and to respond may be used to determine velocity.

Further, some Apps may not provide for access to raw metrics or statistics yet these measures could be derived via traffic patterns or Application usage patterns derived from generated data traffic types or headers, forefront application usage, CPU or Memory usage or other related sensors that can be used to derive, estimate, or project such raw usage metrics.

Additional traffic types and raw transactions may be large in nature, such as the distribution of a video feed, a broadcast, webinar or audio track. The metrics for such mediums may include the time it took to start the broadcast, the amount of time it took to finish it, the number of sessions etc.

Alternately, on slower devices or where it is not possible to capture this data in real time on an email by email basis, a mean average calculated at the end of the day or at sufficient intervals to update the calculation may be used as long as the individual transactional data is available, even if gathered in batches at fixed intervals (i.e. it took 20 seconds to respond, even if this is only determined 24 hours later).

It is important to note that a response to a communication is not always made by using the same communication medium as it was initiated on. For example, an email may be received and the recipient responds by calling the person or may respond by quickly sending a text message. In these cases it's important to ensure that these responses are linked and that the reply by phone call to the same contacts phone number as the email was received from must be noted as the response time to the email.

Some communications may also continue to be sent back and forth until it is no longer clear who the initiator is and who the responder is (e.g., one email goes out with many questions to many people). The recipients of the initial email reply back to the group with more questions to yet others on the group. In this case the subject line will be key to tying the email thread together and while individual velocities in terms of email response are measured, the aggregate velocity of the thread or subject may be computed when the thread is concluded.

In other cases, unrelated emails may cross paths and cannot be mixed up with responses and requests. In this case, the subject line can be key to tying the email thread together. However, at times, the subject line alone may not be adequate since multiple conversations can spawn from a single email thread.

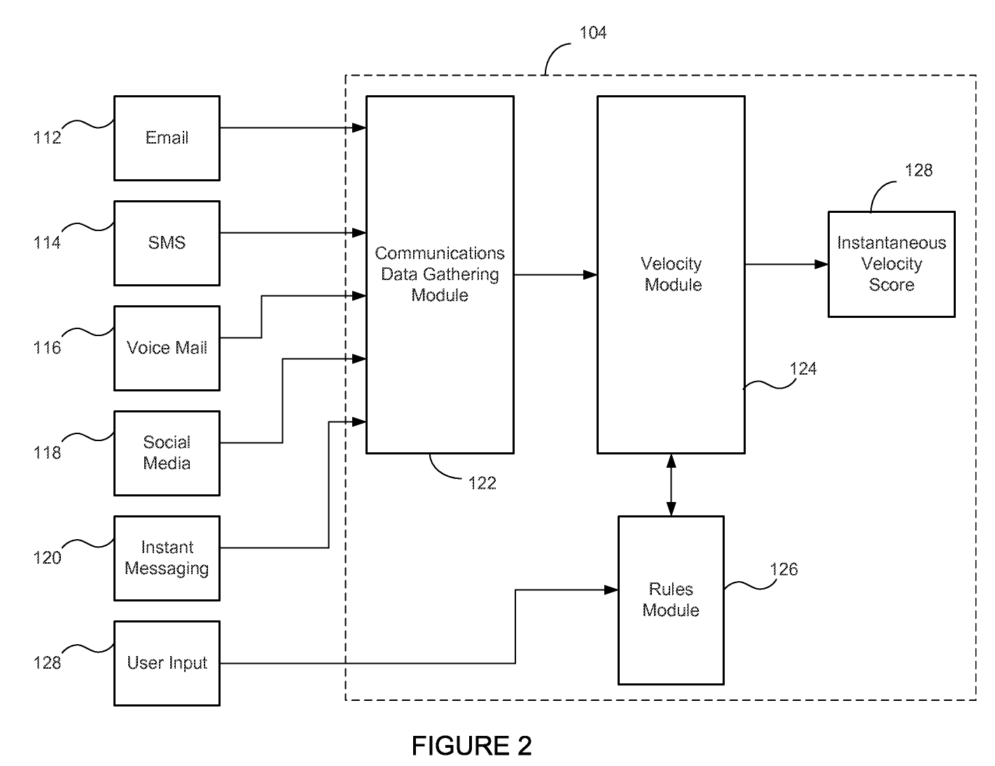

Turning now to FIG. 2 a block diagram show the functionality of software 104 (that executes on system computer 102) is illustrated. Illustrated in FIG. 2 is communications data gather module 122, velocity module 124 and rules module 126.

Communications data gather module 122 is provided to gather the raw communications data from the various communications mediums discussed in connection with FIG. 1. While communications data gather module 122 is depicted as software 104 executing on system computer 102, it is understand that this module may, in one embodiment, further comprise an application(s) (app) that may be installed on an individual's mobile device. For example, raw communications data may be taken from the devices on which the communication is initiated, or on systems that are used to aggregate or forward communications (e.g., switches, etc.). An email system could provide raw communications data for individuals, or alternately each of the target platforms on which email is running can provide the data from each transaction. The SMS switch that handles text messages can provide the raw data, or the end device on which the SMS is initiated can capture and provide the raw data.

Velocity module 124 receives the raw communications data collected by communications data gather module 122 for use in generating a velocity score. Rules module 126 provides rules for weighting the various raw communications data.

Factors that affect the calculation of velocity can be set or configured by a user input 128. These factors can be assigned various weights that will impact the velocity score. For example, an entity may decide that email is the primary communications medium that it wishes its employees to utilize. Responses sent via email would inherently receive a higher weighting for determining a velocity score. Individual velocity determinations can be calculated on each media type. These individual velocity determinations can further be calculated to determine a velocity score that could be attributed to an individual, a department, an entity, or even a system or automated machine based on the weighted averages.

Some communications may be excluded completely from the factors in determining velocity. For example, while a velocity determination on social media tools may be calculated, management may decide not to use these in the weighted average by assigning zero weight to their values.

Similarly, the destination and source of communications can be a factor into the calculation with a set of established weights. Communications with customers may, for example, have the highest weighted values. Similarly, upwards communications to superiors at work may take a heavier weight in velocity calculations than communications to peers or subordinates. Whereas, communications from solicitors or suppliers or telemarketers may hold a relatively low or even zero weight in the calculation of velocity.

Time of day and day of the week can also be used in determining velocity. For example, communications during regular business hours can factor heavily in an individual's velocity score, followed by after-hours or before-hours windows. Weekends or off time, and lastly, vacation time and other calendar events and sleeping times may factor much lower in determining an individual's velocity score.

Another weight that can be calculated in the rules module 126 is the frequency and amount of communications received by particular individuals, groups of individuals or departments. For example, a manager may receive a higher volume of communications than other employees, and such manager may be working on multiple projects at once. In some cases, the manager's responsiveness to each communication would be lower than an individual who does not receive as many communications. However, the overall picture or response score could be weighted to reflect that an individual receiving 20 e-mails per hour would not be expected to respond as quickly as an individual receiving 5 e-mails per hour.

Similar weights can be applied to departments or groups. For example, the customer service department in a company may be expected to have a significantly larger volume of communications in comparison to, for example, the engineering department. Therefore, the system can weigh response scores based on individuals, groups or departments. In other cases, it may be desirable that certain departments are not held to the same responsiveness standards as other departments. Using the example above regarding customer service and engineering, a company may determine that the customer service department should be tasked with a stricter rules regarding how response scores are weighted and generated, because one goal of the company may be to have a high responsiveness score for customer service representatives. Other departments such as product design or engineering would be expected to spend more time working on research, development or manufacturing of various products. Accordingly, the company may wish to avoid penalizing product designers for not being as responsive as the customer service department, since the company may not wish for product designers to make response to e-mails their highest priority. Another weight that can be input into rules module 126 is the “urgency” of a matter on a communications. When operating in a critical job function or tiger team and communications about this project are deemed critical, velocity determinations can be heavily weighted. Alternatively, normal day to day communications weighting may be lowered to a “reasonable”, which may be, depending on the communication and project, a delay of a day or a even a week. The initiator can set a severity or criticality in the request (e.g., email systems allow an urgent flag, as do many voice mail systems when leaving messages).

For communication mediums such as SMS or Text Messaging, the urgency of the message may be designated by, for example, by using a prefix “urgent” in the message. Likewise, the length of the response may be used to calculate velocity.

As another example, weights can reflect the number of projects an individual is involved in and the relative priority of those projects in determining how “urgent” certain communications are in relation to other communications. Weights could reflect the potential revenues or savings associated with particular projects and likewise increase or decrease the weight of the associated communications based on the relative priority to other projects. Other weights could account for deadlines, milestones or other steps associated with various projects.

In some cases, the individual sending a communication may forget to mark communications as “urgent.” Therefore, in associating a weight to particular communications, the subject or content of the communications can be taken into account and compared to pending projects, deadlines, revenues, milestones or other related data in order to determine a weight based on how urgent a communication is in relation to other communications. In one aspect, the system may highlight or categorize communications by urgency so that individuals looking to attend to urgent communications have a priority list of communications that may be set based on weights.

In some cases, particular communications may request certain actions. For example, an e-mail that requests a call back would be associated with an expected response of a phone call. Other e-mails could be sent from one individual to another requesting that the recipient call a third party. The velocity score can take into account how quickly the requested phone call is completed. It would also be understood that an immediate call back may not be expected in some cases. For example, a phone call may be expected to require preparation, investigation or other work prior to initiating the phone call. The company would likely wish to encourage quick responsiveness; however a slower and better prepared responsiveness would be more desirable than a fast and un-prepared response.

More formal communications such as a service request or a delivery commitment may have a formal service level agreement (SLA) which dictates the weighting of a velocity measurement. If customer support has a 60 minute response time as outlined in an SLA, a response exceeding the 60 minute limit may quickly degrade a velocity score. Alternatively, a response within the 0-60 minute window may hold a much higher score in a narrower range. These values can be fully customized in the system by the entities deploying them.

Even within the normal daily scope of activities the weighting of velocity determinations can vary depending on the nature of the communications. Communications relating directly to top line increases or bottom line decreases may be attributed significant weight, while the usual weekly update meetings or more mundane topics may have little or no weight. For example, weighting may be adjusted based on the inclusion of a “keyword” in the communication in which very important or critical projects receive and adjusted weighting compared to repetitive or mundane communications.

As depicted in FIG. 2, velocity module 124 will take in the various raw communications data received from communications data gathering module 122 and apply the various weighting to the raw communications data as outlined in rules module 126. The result is the generation of an instantaneous velocity score 128.

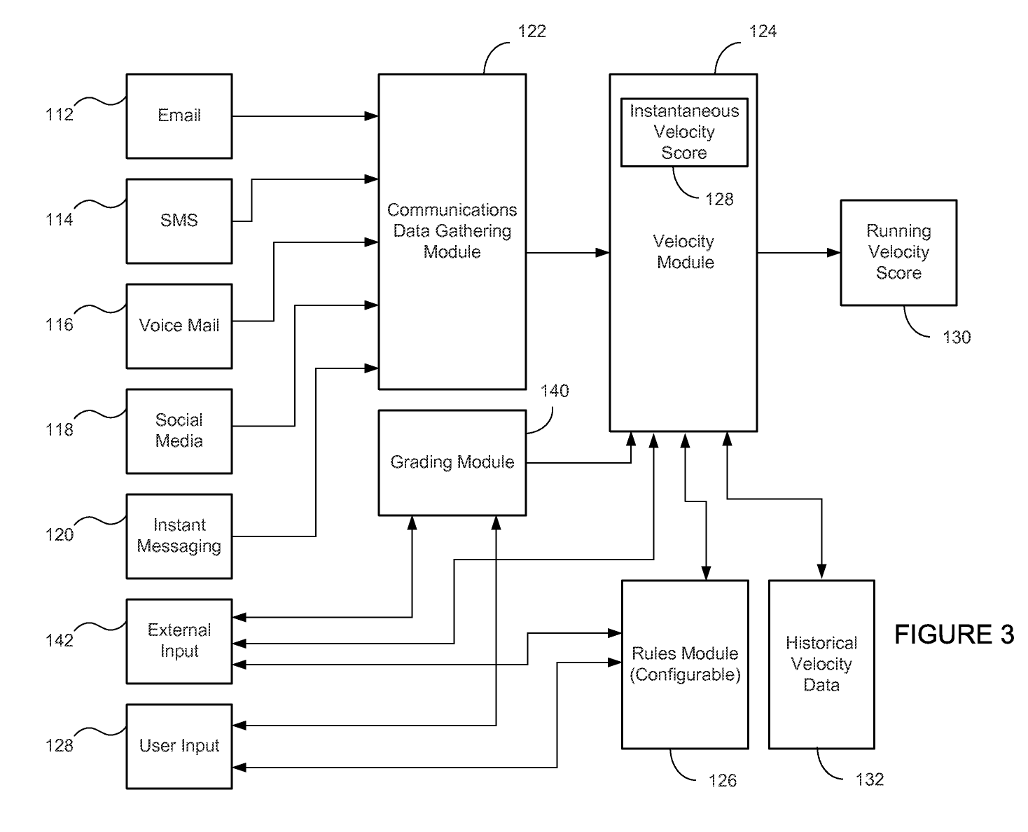

The velocity score may be any range of alpha-numeric figures, but in one embodiment is a score ranging from 0-100. While velocity module may calculate numerous velocity scores, any one may be accessed or an instantaneous velocity score can be presented, as well as a running velocity score 130 (e.g., monthly, daily, etc.) (see, FIG. 3) can be generated on demand or a set intervals.

As seen in FIG. 3, a running velocity score 130 may be generated by velocity module 124 that takes into consideration historical velocity data 132 that may have been generated and saved over a period of time.

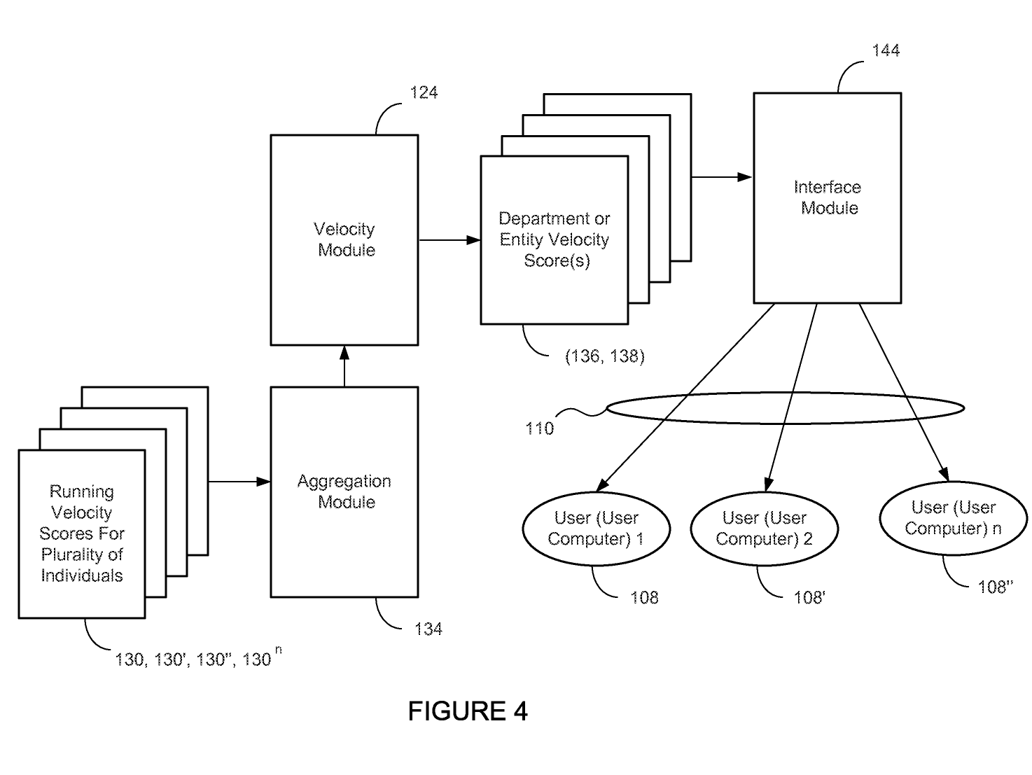

It should be understood that the running velocity score discussed above generated in connection with an individual, can be generated for a plurality of individuals (130, 130′, 130″, 130ⁿ) as shown in FIG. 4. This plurality of running velocity scores can be aggregated by aggregation module 134. It should be noted that any number of running velocity scores can be aggregated based on criteria set by a user input. For example, it may be desired to determine not only an individual(s) velocity scores, it may be desired to determine a department velocity score 136. Likewise, it may be desired to aggregate a number or all of the department velocity scores to determine an entity velocity score 138.

FIG. 4 includes interface module 144 that receives velocity data (scores) from velocity module 124. The velocity scores may be individual velocity scores, department velocity scores or entity velocity scores. Likewise, the velocity scores may comprise instantaneous velocity scores, historical velocity scores or running velocity scores. All of this velocity score data is accessible a user via a user computer.

In one embodiment, the use of Velocity measurement in an HR capacity can be depicted by providing dashboards to show relative gains, current velocities, and even an interactive real time display of velocity.

Additionally, both an internal facing and public facing velocity can be shown through the aggregate of internal velocities that can depict a company's responsiveness to customers and market needs. For example, a public facing velocity could include an entity's responses to incoming phone calls, problem resolution of issues found, delivery of goods, etc. Another example could be a public facing supplier velocity showing speed of approving work, defining work, and paying invoices, as well as a number of change requests or errors and omissions in orders perhaps.

Business owners and divisional managers could also compare the velocity of their various departments or other companies with industry norms or benchmarks as these values become available.

Inward facing velocities could be more targeted and used in a variety of capacities from the individual to the corporate CEO that wants to see overall corporate performance and responsiveness. Individual employees could look at their own velocity and compare it with departmental average, prior reporting periods to see improvement/degradation, they can also see targets or goals set by management and reporting against it. Departmental managers could view individual velocities of their staff, as well as the velocity of their department in comparison with other departments at the company.

Still in other cases, the geography of where the participants are physically may have an effect on the weights applied or the preferences to technology use. This may be due to cultural preferences in technology adoption, availability of technology, or simply the working habits and pace at which enterprises operate.

A variety of reports could be generated by interface module 144 including a top “x” responders & bottom “y” offenders type of report along with ranking by department, by job function, as well as improvements or changes.

Still further, it should be understood that threshold based alerts could be generated and sent out to various individuals, departments and/or entities. These threshold based alerts could be generated by capturing events and creating triggers when particular employee/department scores fall below a threshold. Using again the example of the customer support department with an SLA, it may have penalties and fines associated with falling below certain levels, so early warning thresholds generated as alerts can provide early warning and avoid costly underperformance. Conversely, positive reinforcement through highlighting those users exceeding target thresholds is also possible.

Threshold based alerts could also be tied to incentive programs where by promotions or other incentives could be tied to either reaching certain fixed thresholds, or by achieving gains in velocity from prior time periods.

Turning back to FIG. 3, also depicted is grading module 140 that receives an external input 142 and is operatively coupled to velocity module 124. It is understood that not only can velocity score be generated based on the timing of a response and modified by the weights in the rules module 126, but the accuracy and quality of the response can also be used in determining a velocity score. A mechanism, such as an end of mail survey or a method by which one could select ‘resolved my issue’, to ‘was little or no help’ can be employed in the email. This could be limited to internal deployment (internal to the entity/company), but could be used to show customers that an entity is measuring and trying to improve efficiency. The external input 142 is illustrated as variously coupled to grading module 140, velocity module 124 and rules module 126. It should be noted that any or all of these feeds may be utilized in any configuration. For example, it may be desirable to accept external data (external input) as a velocity feed, or as a weight or as an external reference to correlate with the system scores, and so on.

Automated systems such as an automated answer system/menu could also be automatically graded based on either a ‘my problem is solved’ selection from the user, or even due to the user no longer navigating the system or menu options. The velocity determination can be used to grade the efficiency of such automated systems based on real users with real problems that are navigating them along with quantifiable measurements of number of keystrokes pressed, time on the line, and a satisfaction answer at the end.

It is understood that it is not practical to burden users with a survey or questions after each email or phone call for grading purposes. The system can therefore present a grading survey or simple selection selectively. A velocity score is initially based on responsiveness. However, the grading aspect of the system would add weight to the quality of responses. A person or entity with largely positive feedback would generally be considered more credible or knowledgeable and their velocity score would be increased using this weight system.

An example of a table including running velocity calculations is provided below as an example of how velocity can be calculated. The following example is presented to further illustrate and explain the present invention and should not be taken as limiting in any regard.

TABLE 1

| | | | | Velocity after | | | Solution | | Number of |
|---|---|---|---|---|---|---|---|---|---|
| | | | | Media specific | Add | Add Time | Bonus or | Resultant | aggregate |
| | | | | Normalization | Context | of Day | Helpful | Average | Data |
| Date/Time | Individual | Resp Time | | Formula | Weight | Weight | Vote | Velocity | Points |
| Jan 1, 12:21 | Voice | 10 | mins | 90 | | | | 90 | 1 |
| | calls | | | | | | | | |
| Jan 1, 13:21 | SMS | 2 | mins | 95 | | | | 92.5 | 2 |
| | messages | | | | | | | | |
| Jan 1, 14:21 | Calendar | 4 | hrs | 80 | | | | 88.3 | 3 |
| | invites | | | | | | | | |
| Jan 1, 14.21 | Voice Mail | 2 | hrs | 85 | | | | 87.5 | 4 |
| | replies | | | | | | | | |
| Jan 1, 15:21 | Email | 10 | mins | 95 | | | | 89 | 5 |
| | thread | | | | | | | | |
| Jan 1, 16:21 | Very important | 10 | mins | 95 | *2 | | | 90.7 | 7 |
| | email | | | | | | | | |
| Jan 1, 18:21 | Very important | 10 | mins | 95 | *2 | *3 | *5 | 93.2 | 17 |
| | email after hours | | | | | | | | |
| Jan 1, 19:21 | Very important | 13 | hours | 50 | *2 | *3 | | 83.1 | 22 |
| | email after hours | | | | | | | | |

In Table 1, weights are employed by using multiple instances of the raw velocity measurement. Any of the following weighting could, for example, be used to determine velocity. Wmd=(Medium Weight)=10 company preferred communication medium, 8 acceptable communications medium for corporate communications, 0=not used for corporate communications. Wtd=(Weight Time Day) Values=10 Heightened Crisis, 8 Normal business hours, 6 after hours, 4 weekends or holidays, 0=night/sleep time. Wta=(Weight Target Audience) Values=5 Customers, 4 Superiors 3, peers 2, subordinates and/or suppliers 1.

Some systems do offer auto-responders and replies such as vacation alerts, or a simple out of office acknowledgement. The system would factor these out of having any merit in the calculations except in some circumstances. For example, auto-response emails may be used as an indicator that a person is not available at a given time, for personal or company reasons (such as visiting a customer).

Further, PTO for vacation, or absences is also factored in by applying further weights such as bonus points for a response, but not penalizing the individuals for not responding when on vacation or personal time. Calendar entries in someone's agenda can also be used as indicators for being in meetings, being with customers. Other calendar events such as statutory holidays are also used as PTO.

Referring to Table 1, the first five row are counted as single aggregate points and that no additional weights are assigned. This can be observed by the total number of aggregate points per column, which is the last column of the table. In row 6, on January 1, at 16:21, there is an additional context weight (*2) that is illustrated, which essentially adds two data points instead of one. The end result is that this instantaneous velocity score (95) is counted twice in the aggregate. This is observed by seeing that the total number of aggregate points goes up by two, and the aggregate score factors the instantaneous value twice. The next row, on January 1, at 18:21, weights are added for multiple columns which add up to a total of 10 multiples. Once again, the instantaneous velocity score (95) is counted 10 times in the calculation of the aggregate values and the total number of aggregate values goes up by 10.

In another example, if there was a single value of 10, the aggregate count would be 1 and the aggregate value would be 10. If a second point of 8 were added, an instantaneous value of 8 would be generated, 2 aggregate values, and a new aggregate value of (10+8)/2=9. When using weights, taking the same example above but instead of having a single aggregate value of 8 as the second measurement, weights were added as per row 6 in the table with a weight value of *2, an aggregate calculation as follows (10+(8*2))/3=8.67 would be obtained.

The above example is only one example of implementing the algorithm and should not be viewed as limiting the scope of the invention.

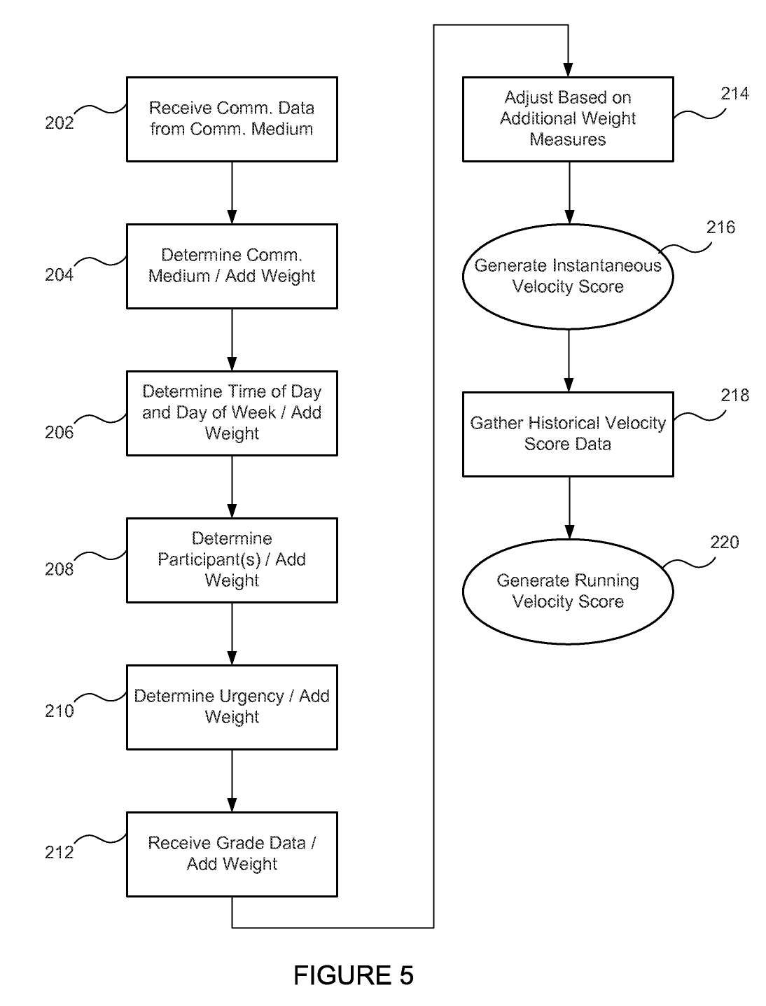

FIG. 5 is a flow diagram illustrating the weighting of received raw communication data performed by velocity module 124. Velocity module 124 receives communications data from a communications medium 202. Once received, velocity module 124 then determines the communications medium used 204 and applies a weight based on the rules in the rules module 126 (e.g. email preferred so email provides higher weighting).

After the weighting for the communications medium is applied, a determination of the time of day and the day of the week 206 that the communication was sent and the response was sent is determined. Weighting is applied based on the rules in the rules module 126.

Velocity module 124 then determines who the participants were to the communication 208 (communication thread) and applies weighting based on the rules in the rules module 126.

Velocity module 124 then determines an urgency of the communication 210 (communication thread) and applies weighting based on the rules in the rules module 126.

Velocity module 124 then receives grade data of the communication 212 (communication thread) from grading module 140 and applies weighting based on the rules in the rules module 126.

Finally, any additional weights may be applied to the velocity calculation based on user input 214. The result of the application of the various weights to the raw communication data is the generation of an instantaneous velocity score 216 that may be stored in storage 106.

Velocity module 124 may then gather historical velocity score data 218 to generate a running velocity score 220 as previously described herein. All the various velocity scores for individuals, groups of individuals and department, entities, including instantaneous, historical and running velocity scores are available to a user via interface module 144. Likewise the generation of reports, either manually or automatically that are accessible to a user(s) may also be provided by means of interface module 144. It should be understood that alerts, reports, notifications, etc. can be customized by a user in the rules module 126 such that such are automatically sent to a user(s) or a notification that such are available may be pushed out to a user(s).

It is also understood that individuals can be located in different time zones, therefore, based on an individual's location, there may be expected delays in responding. For example if a communication is sent at Noon Eastern to an individual in China, a response may be considered timely if a reply is sent the next morning at 9:00 am China time due to time zone differences. In determining a location of an individual, GPS sensors in mobile devices, motion sensors, computerized calendars and appointments and other information, sensors or data may be used to determine the location of an individual both for the expected responsiveness due to time zone and the expected responsiveness due to potential conflicts with other engagements or appointments. There may also be latency if a translation is required prior to the response

Although the invention has been described with reference to a particular arrangement of parts, features and the like, these are not intended to exhaust all possible arrangements or features, and indeed many other modifications and variations will be ascertainable to those of skill in the art.

What is claimed is:

1. A system for measuring responsiveness of an individual to a communication comprising:
a system computer having a storage accessible thereto and a network connection, said system having software executing thereon including:
a communications data gathering module that gathers data indicative of:
when a communication is sent via a communication medium; and
when a response to the communication is sent;
a rules module that includes rules for applying a weight to the gathered data;
a velocity module generating a velocity score based on the weighted gathered data;
wherein the weight applied to the response time is based on:
the time of day the communication was sent,
the day of the week the communication was sent,
the time of day the response was sent,
the day of the week the response was sent;
wherein the communications medium is selected from the group consisting of: email, text messaging, voicemail, social media, instant messaging or combinations thereof.

2. The system according to claim 1 wherein the individual comprises a plurality of individuals where the system generates a velocity score for each individual.

3. The system according to claim 2 wherein said software further comprises an aggregation module, said aggregation module aggregating the individual velocity scores to generate an aggregated velocity score for said plurality of individuals.

4. The system according to claim 3 wherein said software further includes a interface module, wherein a user may access said interface module via a user computer coupled to a network and wherein the user is presented with a velocity score of said individual, or a velocity score of said plurality of individuals to form a department velocity score, or a plurality of department velocity scores to form an entity velocity score or combinations thereof.

5. The system according to claim 4 wherein said interface module presents a plurality of department velocity scores to the user and/or presents a plurality of entity velocity scores to the user.

6. The system according to claim 1 wherein the weighting of the response time to the communication is adjusted either higher or lower depending on the measured day of the week and time of day the communication is sent and the response is received.

7. The system according to claim 1 wherein when the communications medium is email, the weighting of the response time to the communication is adjusted either higher or lower based on determining an importance of the communication.

8. The system according to claim 1 wherein the weighting of the response time to the communication is adjusted either higher or lower based on determining the communications medium utilized for transmitting the response to the communication.

9. The system according to claim 1 wherein the weighting of the response time to the communication is adjusted either higher or lower based on determining participants of the communication.

10. The system according to claim 1 wherein the weight applied to the response time further includes:
the time of day the communication was received, and
the day of the week the communication was received.

11. The system according to claim 1 wherein said software further comprises a grading module for receiving an input from a participant of the communication, wherein the input comprises data indicative of a grade provided by the participant relating to an effectiveness of the response.

12. The system according to claim 11 wherein said communication comprises a communication thread and said grading module receives thread completion data indicating that the communication thread has ended, and wherein when said grading module determines that the communications thread has ended said grading module prompts the participant to input the grade.

13. The system according to claim 1 wherein said velocity score comprises a value extending in a range from 0-100.

14. The system according to claim 1 wherein said rules are configurable.

15. The system according to claim 1 wherein the velocity score generated by said velocity module comprises an instantaneous velocity score that is saved on said storage, said system further comprising historical velocity data stored on said storage, said historical velocity data comprising a plurality of instantaneous velocity scores saved over a time period, wherein said velocity module generates a running velocity score related to the plurality of instantaneous velocity scores saved over the time period.

16. A method for measuring responsiveness of an individual to a communication including a system computer having a storage accessible thereto and a network connection, the system computer having software executing thereon and performing the following steps:
gathering communications data, the communications data indicative of:
when a communication is sent via a communication medium; and
when a response to the communication is sent;
accessing a rules module including rules and applying a weight to the gathered data for determining a velocity score, wherein the weight applied to the gathered data is based on:
the time of day the communication was sent,
the day of the week the communication was sent,
the time of day the response was sent,
the day of the week the response was sent;
generating a velocity score based on the weighted gathered data;
wherein the communications medium is selected from the group consisting of: email, text messaging, voicemail, social media, instant messaging or combinations thereof.

17. The method according to claim 16 wherein the individual comprises a plurality of individuals and the method further comprises the step of generating a velocity score for each individual.

18. The method according to claim 17 wherein the software includes an aggregation module, said method further comprising the step of aggregating the individual velocity scores to generate an aggregated velocity score for the plurality of individuals.

19. The method according to claim 18 wherein said software includes a interface module and a user may access the interface module via a user computer coupled to the network, the method further comprising the step of presenting the user with a velocity score of the individual, or a velocity score of the plurality of individuals to form a department velocity score, or a plurality of department velocity scores to form an entity velocity score or combinations thereof.

20. The method according to claim 16 wherein the weighting of the response time to the communication is adjusted either higher or lower depending on the measured day of the week and time of day the communication is sent and the response is received.

21. The method according to claim 16 wherein when the communications medium is email, the weighting of the response time to the communication is adjusted either higher or lower based on determining an importance of the communication.

22. The method according to claim 16 wherein the weighting of the response time to the communication is adjusted either higher or lower based on determining the communications medium utilized for transmitting the response to the communication.

23. The method according to claim 16 wherein the weighting of the response time to the communication is adjusted either higher or lower based on determining participants of the communication.

24. The method according to claim 16 wherein the software includes a grading module, the method further comprising the step of receiving an input from a participant of the communication, wherein the input comprises data indicative of a grade provided by the participant relating to an effectiveness of the response.

25. The method according to claim 24 wherein the communication comprises a communication thread, the method further comprising the steps of:
receiving thread completion data indicating that the communication thread has ended,
determining that the communications thread has ended, and
prompting the participant to input data indicative of the grade.

26. The method according to claim 16 wherein the velocity score is a value extending in a range from 0-100.

27. The method according to claim 16 wherein said rules module is accessible by a user with a user computer, the method further comprising the step of configuring the rules in the rules module via the user computer.

28. The method according to claim 16 wherein the velocity score generated comprises an instantaneous velocity score, the method further comprising the step of saving the instantaneous velocity score on a storage.

29. The method according to claim 28 further comprising the steps of saving a plurality of instantaneous velocity scores over a period of time.

30. The method according to claim 29 further comprising the step of generating a running velocity score related to the plurality of instantaneous velocity scores saved over the time period.

31. A system for measuring responsiveness of an individual to a communication comprising:
a system computer having a storage accessible thereto and a network connection, said system having software executing thereon including:
a communications data gathering module that gathers data indicative of:
when a communication is sent via a communication medium; and
when a response to the communication is sent;
a rules module that includes rules for applying a weight to the gathered data; and
a velocity module generating a velocity score based on the weighted gathered data.

32. The system according to claim 31 wherein the weighting of the response time to the communication is adjusted either higher or lower depending on the measured day of the week and time of day the communication is sent and the response is received.

33. The system according to claim 31 wherein when the communications medium is email, the weighting of the response time to the communication is adjusted either higher or lower based on determining an importance of the communication.

34. The system according to claim 31 wherein the weighting of the response time to the communication is adjusted either higher or lower based on determining the communications medium utilized for transmitting the response to the communication.

35. The system according to claim 31 wherein the weighting of the response time to the communication is adjusted either higher or lower based on determining participants of the communication.

36. The system according to claim 31 wherein the weight applied to the response time further includes:
the time of day the communication was received, and
the day of the week the communication was received.

37. The system according to claim 31 wherein said software further comprises a grading module for receiving an input from a participant of the communication, wherein the input comprises data indicative of a grade provided by the participant relating to an effectiveness of the response.

38. The system according to claim 31 wherein said rules are configurable.

39. The system according to claim 31 wherein the velocity score generated by said velocity module comprises an instantaneous velocity score that is saved on said storage, said system further comprising historical velocity data stored on said storage, said historical velocity data comprising a plurality of instantaneous velocity scores saved over a time period, wherein said velocity module generates a running velocity score related to the plurality of instantaneous velocity scores saved over the time period.

40. The system according to claim 31 wherein the communications medium is selected from the group consisting of: email, text messaging, voicemail, social media, instant messaging or combinations thereof.
